(19) United States
(12) Patent Application Publication
(10) Pub. No.: US 2020/0122497 A1
(43) Pub. Date: Apr. 23, 2020

(54) THERMOCHROMIC DISPLAY BOARD

(71) Applicant: Lintec of America, Inc., Richardson, TX (US)

(72) Inventors: Jaeah Lee, Richardson, TX (US); James Penney, Richardson, TX (US)

(73) Assignee: Lintec of America, Inc., Richardson, TX (US)

(21) Appl. No.: 16/578,835

(22) Filed: Sep. 23, 2019

Related U.S. Application Data
(60) Provisional application No. 62/747,710, filed on Oct. 19, 2018.

(51) Int. Cl. B41M 7/00; B41M 5/28; G09F 3/00

(52) U.S. Cl. CPC B41M 7/009; G09F 3/0294; B41M 5/282

(57) ABSTRACT

A thermochromic display board is described that includes an array of nanofiber yarns in contact with an electrode. When electrified, the nanofiber yarns generate heat. This heat causes a thermochromic transition in a thermochromic layer. The presence of the nanofiber yarns, which are thermally conductive, can increase the rate at which the thermochromic layer within the di splay board transitions between thermochromic states.

### TECHNICAL FIELD

The present disclosure relates generally to carbon nanofibers. Specifically, the present disclosure relates to a thermochromic display board that includes carbon nanofiber yarns.

### BACKGROUND

Nanofiber forests, composed of both single wall and multiwalled nanotubes, can be drawn into nanofiber ribbons or sheets. In its pre-drawn state, the nanofiber forest comprises a layer (or several stacked layers) of nanofibers that are parallel to one another and perpendicular to a surface of a growth substrate. When drawn into a nanofiber sheet, the orientation of the nanofibers changes from perpendicular to parallel relative to the surface of the growth substrate. The nanotubes in the drawn nanofiber sheet connect to one another in an end-to-end configuration to form a continuous sheet in which a longitudinal axis of the nanofibers is parallel to a plane of the sheet (i.e., parallel to both of the first and second major surfaces of the nanofiber sheet). The nanofiber sheet can be treated in any of a variety of ways, including spinning the nanofiber sheet into a nanofiber yarn.

### SUMMARY

Example 1 is an apparatus comprising: a layer comprising an optically transparent material; a thermochromic layer comprising a thermochromic material; a plurality of carbon nanofiber yarns between the layer comprising the optically transparent material and the thermochromic layer, the plurality of carbon nanofiber yarns in contact with the thermochromic layer; and at least one electrode in contact with the plurality of carbon nanofiber yarns.

Example 2 includes the subject matter of Example 1, wherein: the thermochromic material has a first thermochromic state at a first temperature below a thermochromic transition temperature; the thermochromic material has a second thermochromic state at a second temperature above the thermochromic transition temperature, and wherein the thermochromic material is configured to transition from the first thermochromic state to the second thermochromic state in less than 30 seconds after transitioning between the first temperature and the second temperature.

Example 3 includes the subject matter of either of Examples 1 or 2, wherein the plurality of carbon nanofiber yarns is configured to increase in temperature by at least 25° C. in less than 30 seconds in response to an applied power of at least 500 Watt/meter².

Example 4 includes the subject matter of any of the preceding Examples, wherein the thermochromic layer comprises a leuco dye.

Example 5 includes the subject matter of any of the preceding Examples, wherein the leuco dye comprises a plurality of polymer beads, the leuco dye disposed within the polymer beads.

Example 6 includes the subject matter of any of the preceding Examples, wherein the plurality of carbon nanofiber yarns comprises an array of linearly arranged carbon nanofibers.

Example 7 includes the subject matter of Example 6, further comprising at least one carbon nanofiber yarn in electrical contact with each linearly arranged carbon nanofiber of the array, the at least one carbon nanofiber yarn disposed at an angle greater than 0° relative to the linearly arranged carbon nanofiber yarns.

Example 8 includes the subject matter of any of the preceding Examples, wherein the plurality of carbon nanofiber yarns comprises a grid of transversely arranged carbon nanofiber yarns.

Example 9 includes the subject matter of any of the preceding Examples, wherein a pitch between adjacent carbon nanofiber yarns is from 200 μm to 1 mm.

Example 10 includes the subject matter of any of the preceding Examples, wherein the carbon nanofiber yarns of the plurality are single ply carbon nanofiber yarns.

Example 11 includes the subject matter of any of the Examples 1-9, wherein the carbon nanofiber yarns of the plurality are multi-ply carbon nanofiber yarns.

Example 12 includes the subject matter of any of the preceding Examples, wherein a diameter of a carbon nanofiber yarn of the plurality is from 5 μm to 100 μm.

Example 13 includes the subject matter of any of the preceding Examples, further comprising a second material disposed within the carbon nanofiber yarns of the plurality of carbon nanofiber yarns, wherein the second material is one of an electrical conductor or an electrical resistor.

Example 14 includes the subject matter of any of the preceding Examples, further comprising an adhesive layer between the layer of optically transparent material and the plurality of nanofiber yarns.

Example 15 includes the subject matter of any of the preceding Examples, further comprising a backing plate on a side of the thermochromic layer opposite the plurality of carbon nanofiber yarns.

Example 16 is a method comprising: providing a thermochromic display board that includes a thermochromic layer displaying a first color, a clear layer, and a plurality of nanofiber yarns between the thermochromic layer and the clear layer; writing on the clear layer using a writing material having a second color that contrasts with the first color of the thermochromic layer; applying an electrical current to the plurality of nanofiber yarns, the applied current causing an increase in temperature of the nanofiber yarns and the thermochromic layer; and responsive to the increased temperature, the thermochromic layer transitioning to a third color.

Example 17 includes the subject matter of Example 16, wherein the third color of the thermochromic layer conceals the second color of the writing.

Example 18 includes the subject matter of either of Examples 16 or 17, wherein the third color matches the second color of the writing.

Example 19 includes the subject matter of any of Examples 16-18, wherein the transition to the third color occurs less than 20 seconds after the electrical current is applied to the plurality of nanofiber yarns.

Example 20 includes the subject matter of any of Examples 16-19, wherein the applied electrical current is applied at a voltage of 15 Volts.

Example 21 is a method comprising providing a thermochromic display board that includes: a thermochromic layer displaying a first color; an optically clear layer over the thermochromic layer; a plurality of carbon nanofiber yarns between the thermochromic layer and the optically clear layer; marking the optically clear layer with a writing material having a second color that contrasts with the first color of the thermochromic layer; applying an electrical current to the plurality of carbon nanofiber yarns, the applied current causing an increase in temperature of the carbon nanofiber yarns; and responsive to the increased temperature of the carbon nanofiber yarns, conducting heat to the thermochromic layer thereby causing the thermochromic layer to transition a third color.

Example 22 includes the subject matter of Example 21, wherein the third color of the thermochromic layer does not contrast with the second color of the writing.

Example 23 includes the subject matter of Examples 21-22, wherein the third color matches the second color of the writing.

Example 24 includes the subject matter of Examples 21-23, wherein a Weber contrast value between the second color of the marking on the optically clear layer and the third color of the thermochromic layer is less than 0.3.

Example 25 includes the subject matter of Examples 21-24, wherein a Weber contrast value between the second color of the marking on the optically clear layer and the first color of the thermochromic layer is greater than 0.3.

Example 26 includes the subject matter of Examples 21-25, wherein the transition to the third color occurs less than 20 seconds after the electrical current is initially applied to the plurality of carbon nanofiber yarns.

Example 27 includes the subject matter of Examples 21-26, wherein the applied electrical current is has a voltage of 15 Volts.

Example 28 includes the subject matter of Examples 21-27, wherein the plurality of carbon nanofiber yarns is configured to increase a temperature of the thermochromic layer by at least 25° C. in less than 30 seconds in response to an applied power of at least 500 Watt/meter².

Example 29 includes the subject matter of Examples 21-28, wherein the thermochromic layer has a thermochromic transition temperature of 45° C.+/−5° C.

Example 30 includes the subject matter of Examples 21-29, wherein a Weber contrast value between the marking on the optically clear layer and the second color of the thermochromic layer is at least 0.3.

Example 31 includes the subject matter of Examples 21-29, wherein the thermochromic layer comprises a leuco dye.

Example 32 includes the subject matter of Example 31, wherein the leuco dye comprises a plurality of polymer beads, the leuco dye disposed within the polymer beads.

Example 33 is providing a thermochromic display board that includes: a thermochromic layer displaying a first color; an optically clear layer over the thermochromic layer; a plurality of nanofiber yarns between the thermochromic layer and the optically clear layer; marking the optically clear layer with a writing material having a second color that matches the first color of the thermochromic layer; applying an electrical current to the plurality of nanofiber yarns, the applied electrical current causing an increase in temperature of the nanofiber yarns; and responsive to the increased temperature of the nanofiber yarns, conducting heat to the thermochromic layer thereby causing the thermochromic layer to transition a third color.

Example 34 includes the subject matter of Example 33, wherein the plurality of nanofiber yarns exhibits a thermal conductivity of greater than 3.0 W/(m-K).

Example 35 includes the subject matter of Examples 33-34, further comprising a second material disposed within the nanofiber yarns of the plurality of nanofiber yarns, wherein the second material is one of an electrical conductor or an electrical resistor.

Example 36 includes the subject matter of Example 33, wherein the second material comprises a plurality of tungsten nanoparticles.

Example 37 includes the subject matter of Examples 33-36, wherein the third color contrasts with the second color of the marking.

Example 38 includes the subject matter of Examples 33-37, wherein a Weber contrast value between the second color of the marking on the optically clear layer and the third color of the thermochromic layer is greater than 0.3.

Example 39 includes the subject matter of Examples 33-38, wherein a Weber contrast value between the second color of the marking on the optically clear layer and the first color of the thermochromic layer is less than 0.3.

Example 40 includes the subject matter of Examples 33-39 wherein the plurality of carbon nanofiber yarns is configured to increase a temperature of the thermochromic layer by at least 25° C. in less than 30 seconds in response to an applied power of at least 500 Watt/meter².

Example 41 includes the subject matter of Examples 33-40, wherein the applied current is 0.62 Amps.

### BRIEF DESCRIPTION OF THE DRAWINGS

FIG. 1 illustrates an example forest of nanofibers on a substrate, in an example of the present disclosure.

FIG. 2 is a schematic view of a furnace for the growth and synthesis of a nanofiber forest, in an example of the present disclosure.

FIG. 3 is an illustration of a nanofiber sheet that identifies relative dimensions of the sheet and schematically illustrates nanofibers within the sheet aligned end-to-end in a plane parallel to a surface of the sheet, in an example of the present disclosure.

FIG. 4 is an image of a nanofiber sheet being laterally drawn from a nanofiber forest, the nanofibers aligning from end-to-end as schematically shown in FIG. 3.

FIG. 5A is an image of a single ply, false twisted nanofiber yarn, in an example of the present disclosure.

FIG. 5B is an image of a multi ply nanofiber yarn in which multiple individual nanofiber yarns have been twisted (plied) together, in an example of the present disclosure.

FIG. 6A illustrates a thermochromic nanofiber drawing board in a first thermochromic state in which writing on the board contrasts with a first color state of a thermochromic layer of the thermochromic nanofiber drawing board, in an example of the present disclosure.

FIG. 6B illustrates a thermochromic nanofiber drawing board in a second thermochromic state in which the writing on the board depicted in FIG. 6A is concealed by the second color state of the thermochromic layer of the thermochromic nanofiber drawing board, in an example of the present disclosure.

FIG. 7A is an exploded view of a thermochromic nanofiber drawing board, in an example of the present disclosure.

FIG. 7B is a perspective view of a thermochromic nanofiber drawing board, in an example of the present disclosure.

FIGS. 8-11B illustrate various electrical characteristics of a thermochromic nanofiber drawing board, in an example of the present disclosure.

FIG. 12 is a method flow diagram illustrating an example method for assembling a thermochromic nanofiber drawing board, in an example of the present disclosure.

FIG. 13 is a method flow diagram illustrating an example method for using a thermochromic nanofiber drawing board, in an example of the present disclosure.

The figures depict various embodiments of the present disclosure for purposes of illustration only. Numerous variations, configurations, and other embodiments will be apparent from the following detailed discussion. Furthermore, as will be appreciated, the figures are not necessarily drawn to scale or intended to limit the described embodiments to the specific configurations shown. For instance, while some figures generally indicate straight lines, right angles, and smooth surfaces, an actual implementation of the disclosed techniques may have less than perfect straight lines and right angles, and some features may have surface topography or otherwise be non-smooth, given real-world limitations of fabrication processes. In short, the figures are provided merely to show example structures.

### DETAILED DESCRIPTION

### Overview

Temperature sensitive labels or indicators that change color and/or opacity (alternatively, transparency) upon a change in temperature have many practical applications. In some cases, thermochromic materials such as polymers (e.g., liquid crystal polymers) and/or pigments (e.g., leuco dyes) are fabricated as a thermochromic layer. This thermochromic layer can be placed proximate to a source of thermal energy (e.g., a heating source or cooling source). As thermal energy is applied to (or removed from) the thermochromic layer, it changes color or, more generally, transitions to an alternative state (e.g., from opaque to transparent, vice versa, or from a first color to a second color). For example, some leuco dyes can turn from blue to pink upon arriving at and/or exceeding a temperature of approximately 12° C. (+/−5° C.). In another example, a layer that includes suitably composed liquid crystals can transition from black to transparent as the temperature increases to an upper threshold (e.g., above 40° C., above 60° C., or above 100° C.).

Example applications of thermochromic materials include test strips on batteries (which, upon actuation, can indicate a level of charge within the battery), thermometer strips that include a plurality of different thermochromic materials that, when ordered in a sequence of ascending transition temperatures adjacent to, and calibrated with, a written temperature scale, indicate an ambient temperature or a temperature of an adjacent surface.

The response time of thermochromic materials can be slow compared to a rate at which an underlying surface changes temperature. For example, in some cases, a thermochromic material (whether leuco dye, liquid crystal polymer, or other thermochromic material) can be placed on a polymer substrate or disposed within a polymer matrix. The thermal conductivity of most polymers is low (e.g., less than 0.5 W/m-K). This low thermal conductivity of the polymer substrate/matrix slows the transport of heat from a heat source to the thermochromic material, which in turn can cause a time delay between a temperature change and a corresponding thermochromic transition of the thermochromic material. This time delay can be on the order of minutes. This delay can make the use or integration of thermochromic materials into products less commercially appealing. Even in the absence of an intervening or encapsulating polymer layer, heat transport from a heat source to a thermochromic layer can be slowed merely by the presence of an interface between the heat source and the thermochromic layer.

Thus, in accordance with some embodiments of the present disclosure, techniques are described for the fabrication and use of a thermochromic display board with a response time (i.e., a time between exposure to a temperature change and a thermochromic transition from opaque to transparent and/or from a first color to a second color) that is less than 30 seconds for a board having an area of 1 square meter (m²). One element of a display board can be, in some examples, a surface layer of clear polymer or glass (or glass ceramic) on which writing can be placed (using, for example, a marker). The thermochromic display board may also include an array of nanofiber yarns in contact with electrodes. The presence of the nanofiber yarns, which are thermally conductive, can increase the rate at which the thermochromic layer within the display board is heated and/or cooled. This improves the convenience and industrial applicability with which embodiments described herein are used.

A color of a marker or other writing instrument can be selected to match a color of the thermochromic polymer either before a thermal transition (“a first thermochromic state”) or after a thermal transition (“a second thermochromic state”). In this way, upon heating or cooling the thermochromic layer of the drawing board, any writing on the clear writing surface can be concealed by the corresponding color of the thermochromic layer. This effect is reversible, thus enabling the writing on the board to be reversibly hidden and revealed.

Prior to describing thermochromic displays of the present disclosure, the fabrication and configuration of nanofiber forests, nanofiber sheets, and nanofiber yarns as described.

### Nanofiber Forests

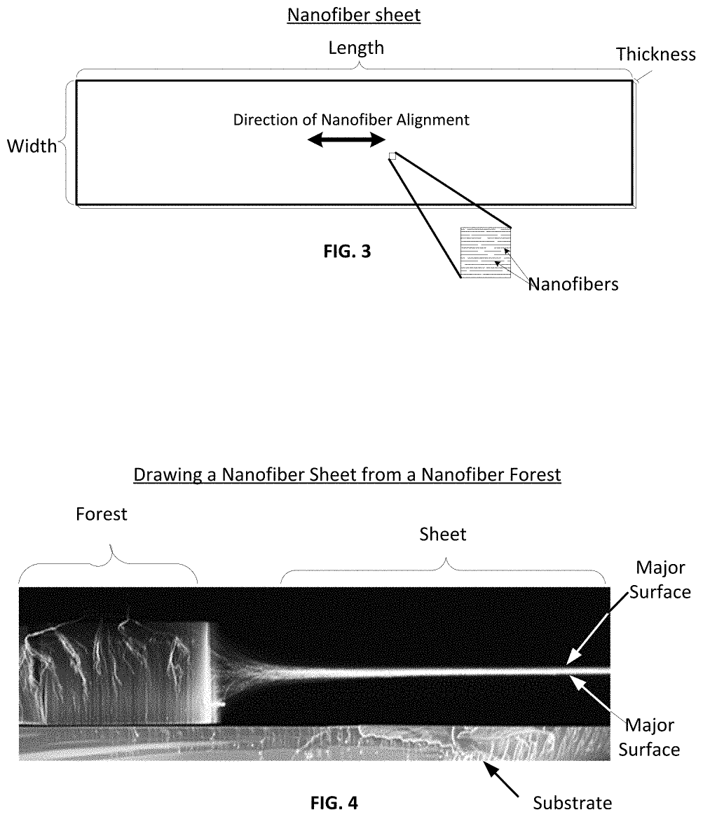

As used herein, the term “nanofiber” means a fiber having a diameter less than 1 μm. While the embodiments herein are primarily described as fabricated from carbon nanotubes, it will be appreciated that other carbon allotropes, whether graphene, micron or nano-scale graphite fibers and/or plates, and even other compositions of nano-scale fibers such as boron nitride may be densified using the techniques described below. As used herein, the terms “nanofiber” and “carbon nanotube” encompass both single walled carbon nanotubes and/or multi-walled carbon nanotubes in which carbon atoms are linked together to form a cylindrical structure. In some embodiments, carbon nanotubes as referenced herein have between 4 and 10 walls. As used herein, a “nanofiber sheet” or simply “sheet” refers to a sheet of nanofibers aligned via a drawing process (as described in PCT Publication No. WO 2007/015710, and incorporated by reference herein in its entirety) so that a longitudinal axis of a nanofiber of the sheet is parallel to a major surface of the sheet, rather than perpendicular to the major surface of the sheet (i.e., in the as-deposited form of the sheet, often referred to as a “forest”). This is illustrated and shown in FIGS. 3 and 4, respectively.

The dimensions of carbon nanotubes can vary greatly depending on production methods used. For example, the diameter of a carbon nanotube may be from 0.4 nm to 100 nm and its length may range from 10 μm to greater than 55.5 cm. Carbon nanotubes are also capable of having very high aspect ratios (ratio of length to diameter) with some as high as 132,000,000:1 or more. Given the wide range of dimensional possibilities, the properties of carbon nanotubes are highly adjustable, or “tunable.” While many intriguing properties of carbon nanotubes have been identified, harnessing the properties of carbon nanotubes in practical applications requires scalable and controllable production methods that allow the features of the carbon nanotubes to be maintained or enhanced.

Due to their unique structure, carbon nanotubes possess particular mechanical, electrical, chemical, thermal and optical properties that make them well-suited for certain applications. In particular, carbon nanotubes exhibit superior electrical conductivity, high mechanical strength, good thermal stability and are also hydrophobic. In addition to these properties, carbon nanotubes may also exhibit useful optical properties. For example, carbon nanotubes may be used in light-emitting diodes (LEDs) and photo-detectors to emit or detect light at narrowly selected wavelengths. Carbon nanotubes may also prove useful for photon transport and/or phonon transport.

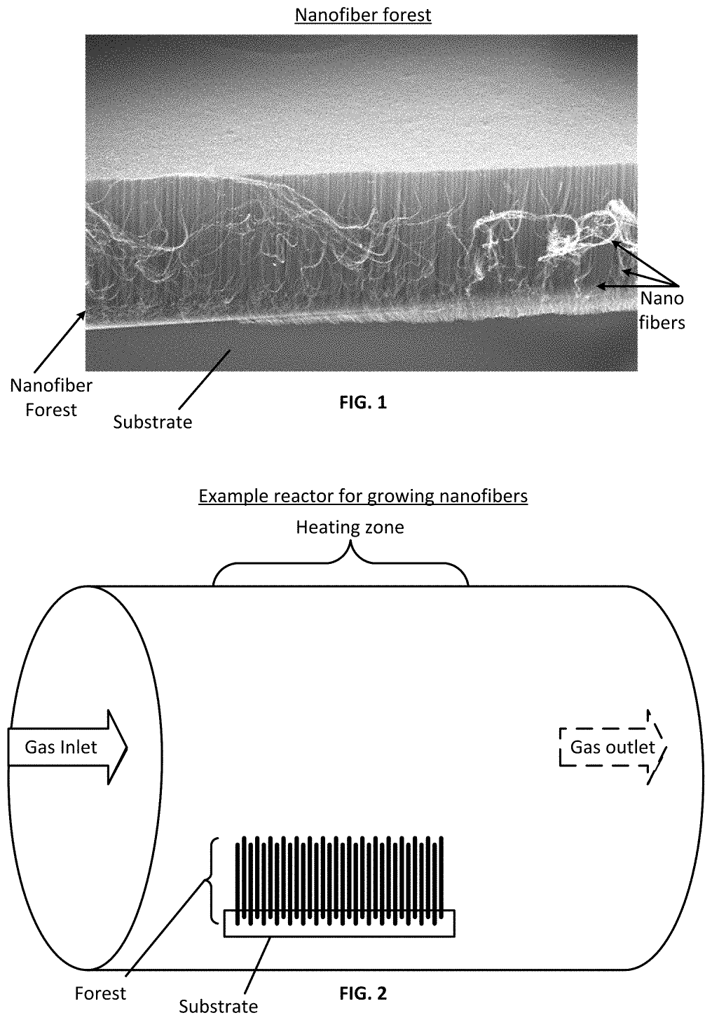

In accordance with various embodiments of the subject disclosure, nanofibers (including but not limited to carbon nanotubes) can be arranged in various configurations, including in a configuration referred to herein as a “forest.” As used herein, a “forest” of nanofibers or carbon nanotubes refers to an array of nanofibers having approximately equivalent dimensions that are arranged substantially parallel to one another on a substrate. FIG. 1 shows an example forest of nanofibers on a substrate. The substrate may be any shape but in some embodiments the substrate has a planar surface on which the forest is assembled. As can be seen in FIG. 1, the nanofibers in the forest may be approximately equal in height and/or diameter.

Nanofiber forests as disclosed herein may be relatively dense. Specifically, the disclosed nanofiber forests may have a density of at least 1 billion nanofibers/cm². In some specific embodiments, a nanofiber forest as described herein may have a density of between 10 billion/cm² and 30 billion/cm². In other examples, the nanofiber forest as described herein may have a density in the range of 90 billion nanofibers/cm². The forest may include areas of high density or low density and specific areas may be void of nanofibers. The nanofibers within a forest may also exhibit inter-fiber connectivity. For example, neighboring nanofibers within a nanofiber forest may be attracted to one another by van der Waals forces. Regardless, a density of nanofibers within a forest can be increased by applying techniques described herein.

Methods of fabricating a nanofiber forest are described in, for example, PCT No. WO2007/015710, which is incorporated herein by reference in its entirety.

Various methods can be used to produce nanofiber precursor forests. For example, in some embodiments nanofibers may be grown in a high-temperature furnace, schematically illustrated in FIG. 2. In some embodiments, catalyst may be deposited on a substrate, placed in a reactor and then may be exposed to a fuel compound that is supplied to the reactor. Substrates can withstand temperatures of greater than 800° C. or even 1000° C. and may be inert materials. The substrate may comprise stainless steel or aluminum disposed on an underlying silicon (Si) wafer, although other ceramic substrates may be used in place of the Si wafer (e.g., alumina, zirconia, SiO₂, glass ceramics). In examples where the nanofibers of the precursor forest are carbon nanotubes, carbon-based compounds, such as acetylene may be used as fuel compounds. After being introduced to the reactor, the fuel compound(s) may then begin to accumulate on the catalyst and may assemble by growing upward from the substrate to form a forest of nanofibers. The reactor also may include a gas inlet where fuel compound(s) and carrier gasses may be supplied to the reactor and a gas outlet where expended fuel compounds and carrier gases may be released from the reactor. Examples of carrier gases include hydrogen, argon, and helium. These gases, in particular hydrogen, may also be introduced to the reactor to facilitate growth of the nanofiber forest. Additionally, dopants to be incorporated in the nanofibers may be added to the gas stream.

In a process used to fabricate a multilayered nanofiber forest, one nanofiber forest is formed on a substrate followed by the growth of a second nanofiber forest in contact with the first nanofiber forest. Multi-layered nanofiber forests can be formed by numerous suitable methods, such as by forming a first nanofiber forest on the substrate, depositing catalyst on the first nanofiber forest and then introducing additional fuel compound to the reactor to encourage growth of a second nanofiber forest from the catalyst positioned on the first nanofiber forest. Depending on the growth methodology applied, the type of catalyst, and the location of the catalyst, the second nanofiber layer may either grow on top of the first nanofiber layer or, after refreshing the catalyst, for example with hydrogen gas, grow directly on the substrate thus growing under the first nanofiber layer. Regardless, the second nanofiber forest can be aligned approximately end-to-end with the nanofibers of the first nanofiber forest although there is a readily detectable interface between the first and second forest. Multi-layered nanofiber forests may include any number of forests. For example, a multi-layered precursor forest may include two, three, four, five or more forests.

### Nanofiber Sheets

In addition to arrangement in a forest configuration, the nanofibers of the present application may also be arranged in a sheet configuration. As used herein, the term “nanofiber sheet,” “nanotube sheet,” or simply “sheet” refers to an arrangement of nanofibers where the nanofibers are aligned end to end in a plane. An illustration of an example nanofiber sheet is shown in FIG. 3 with labels of the dimensions. In some embodiments, the sheet has a length and/or width that is more than 100 times greater than the thickness of the sheet. In some embodiments, the length, width or both, are more than 10³, 10⁶ or 10⁹ times greater than the average thickness of the sheet. A nanofiber sheet can have a thickness of, for example, between approximately 5 nm and 30 μm and any length and width that are suitable for the intended application. In some embodiments, a nanofiber sheet may have a length of between 1 cm and 10 meters and a width between 1 cm and 1 meter. These lengths are provided merely for illustration. The length and width of a nanofiber sheet are constrained by the configuration of the manufacturing equipment and not by the physical or chemical properties of any of the nanotubes, forest, or nanofiber sheet. For example, continuous processes can produce sheets of any length. These sheets can be wound onto a roll as they are produced.

As can be seen in FIG. 3, the axis in which the nanofibers are aligned end-to end is referred to as the direction of nanofiber alignment. In some embodiments, the direction of nanofiber alignment may be continuous throughout an entire nanofiber sheet. Nanofibers are not necessarily perfectly parallel to each other and it is understood that the direction of nanofiber alignment is an average or general measure of the direction of alignment of the nanofibers.

Nanofiber sheets may be assembled using any type of suitable process capable of producing the sheet. In some example embodiments, nanofiber sheets may be drawn from a nanofiber forest. An example of a nanofiber sheet being drawn from a nanofiber forest is shown in FIG. 4.

As can be seen in FIG. 4, the nanofibers may be drawn laterally from the forest and then align end-to-end to form a nanofiber sheet. In embodiments where a nanofiber sheet is drawn from a nanofiber forest, the dimensions of the forest may be controlled to form a nanofiber sheet having particular dimensions. For example, the width of the nanofiber sheet may be approximately equal to the width of the nanofiber forest from which the sheet was drawn. Additionally, the length of the sheet can be controlled, for example, by concluding the draw process when the desired sheet length has been achieved.

Nanofiber sheets have many properties that can be exploited for various applications. For example, nanofiber sheets may have tunable opacity, high mechanical strength and flexibility, thermal and electrical conductivity, and may also exhibit hydrophobicity. Given the high degree of alignment of the nanofibers within a sheet, a nanofiber sheet may be extremely thin. In some examples, a nanofiber sheet is on the order of approximately 10 nm thick (as measured within normal measurement tolerances), rendering it nearly two-dimensional. In other examples, the thickness of a nanofiber sheet can be as high as 200 nm or 300 nm. As such, nanofiber sheets may add minimal additional thickness to a component.

As with nanofiber forests, the nanofibers in a nanofibers sheet may be functionalized by a treatment agent by adding chemical groups or elements to a surface of the nanofibers of the sheet and that provide a different chemical activity than the nanofibers alone. Functionalization of a nanofiber sheet can be performed on previously functionalized nanofibers or can be performed on previously unfunctionalized nanofibers. Functionalization can be performed using any of the techniques described herein including, but not limited to CVD, and various doping techniques.

Nanofiber sheets, as drawn from a nanofiber forest, may also have high purity, wherein more than 90%, more than 95% or more than 99% of the weight percent of the nanofiber sheet is attributable to nanofibers, in some instances. Similarly, the nanofiber sheet may comprise more than 90%, more than 95%, more than 99% or more than 99.9% by weight of carbon.

### Nanofiber Yarns

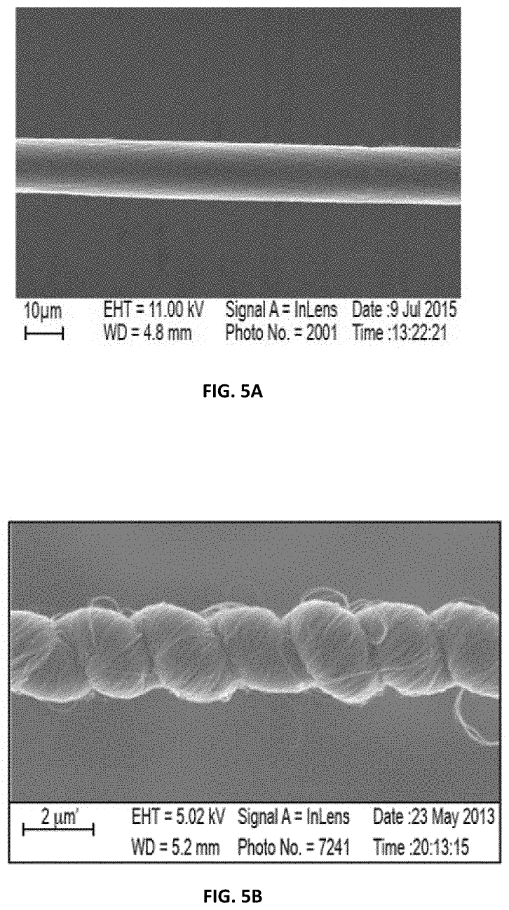

FIG. 5A illustrates the scanning electron microscope (SEM) image of a single ply, false twisted nanofiber yarn of the present disclosure. False twisting techniques are described in U.S. patent application Ser. No. 15/844,756, which is incorporated by reference herein in its entirety. In some examples, a single ply, false twisted nanofiber yarn such as the one illustrated in FIG. 5A, can have a cross-sectional diameter (taken perpendicular to a longitudinal axis of the yarn) within any of the following ranges: from 5 μm to 40 μm; from 5 μm to 30 μm; from 5 μm to 20 μm; from 10 μm to 30 μm; from 50 μm to 40 μm; from 25 μm to 35 μm, less than 40 μm, less than 30 μm, less than 20 μm, greater than 5 μm, greater than 10 μm or greater than 20 μm. In the specific example of the nanofiber yarn shown in FIG. 5A, the cross-sectional diameter is approximately 15 μm. The nanofiber yarn depicted in FIG. 5A has surface topography features that are less than 1 μm (and in some examples less than 0.1 μm) above or below an average location of the surface of the yarn.

FIG. 5B is an SEM micrograph of a multi-ply nanofiber yarn, in an example of the present disclosure. As indicated above, a multi-ply nanofiber yarn can be fabricated by plying together two or more single ply nanofiber yarns. These multi-ply yarns can have increased thermal, electrical, and mechanical properties in proportion to the increased number of fibers to transport heat and/or electricity, or bear a stress.

### Thermochromic Display Board

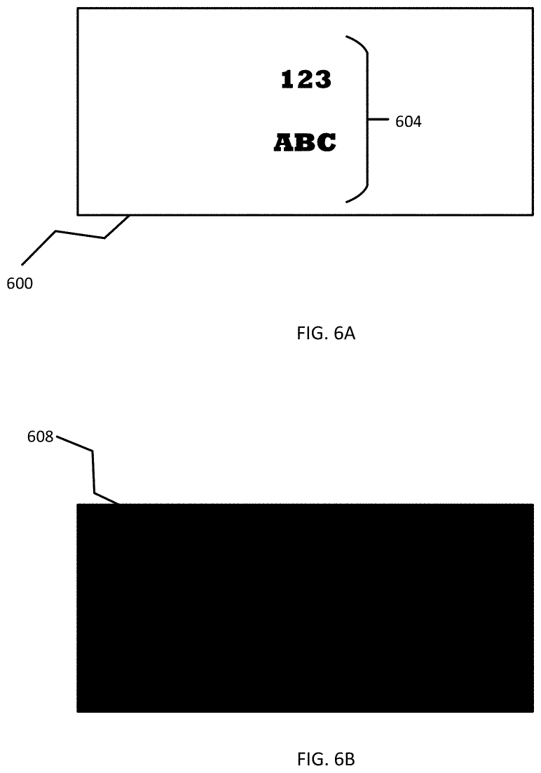

FIGS. 6A and 6B illustrate an application of one embodiment of the present disclosure. As shown in FIG. 6A, the drawing board in a first thermochromic state 600 can include writing 604 on a transparent or clear layer (as described below). For example, a marker or erasable marker can be used to write on a layer of glass ceramic (such as that used in touch sensitive screens of mobile phones) or a clear polymer (e.g., polycarbonate or polyethylene). This first thermochromic state 600 is such that the color of a thermochromic layer contrasts with the color of the marker used for the writing 604.

In comparison to FIG. 6A, FIG. 6B illustrates a thermochromic display board in a second thermochromic state 608. In this second thermochromic state 608, the color of the writing 604 matches that of the second thermochromic state 608. Matching the colors thus conceals the writing 604. As indicated above, the thermochromic states 600 and 608 are reversible thus enabling the writing 604 to be concealed and exposed repeatedly upon heating or cooling the thermochromic layer within the display board. In one example, writing 604 in two different colors (e.g., a first color and a second color different from the first color) can be written on the thermochromic board so that the writing 604 in the first color is revealed and the second color hidden in the first thermochromic state 600. Upon changing to the second thermochromic state 608, the opposite is the case: the first color is concealed and the second color revealed. As also indicated above, because embodiments of the present disclosure include one or more highly conductive nanofiber yarns, switching between the first thermochromic state 600 and the second thermochromic state 608 can be accomplished on the order of seconds.

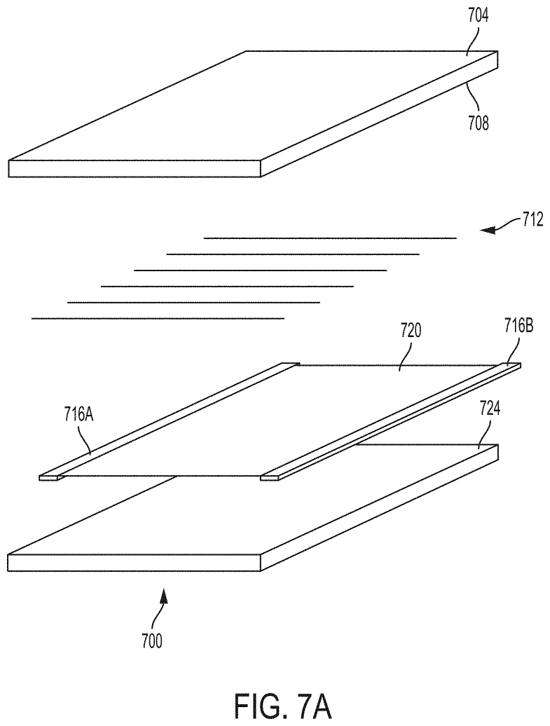

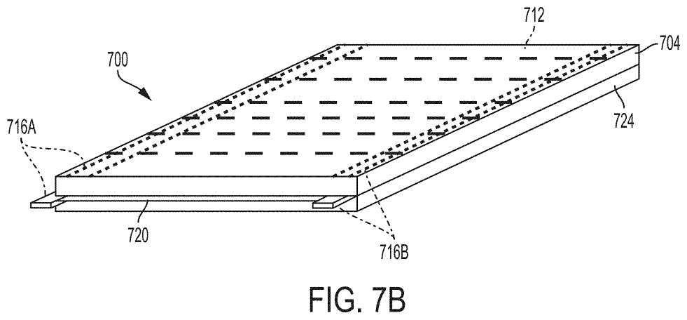

FIGS. 7A and 7B illustrate an exploded view and a perspective view, respectively, of an example thermochromic display board 700 of the present disclosure. Concurrent reference to FIGS. 7A and 7B will facilitate explanation.

The example thermochromic display board 700 illustrated includes a clear layer 704, an array of nanofiber yarns 712, electrodes 716A and 716B, a thermochromic layer 720, and a backing layer 724.

The clear layer 704 provides a writing surface on which a writing material can be applied (e.g., dry erase ink, erasable marker ink, permanent marker ink, grease pencil). Furthermore, the clear layer 704 is optically clear so that a color of the underlying thermochromic layer 720 can be seen through the clear layer 704. As described above, this enables the color of the writing material (such as marker ink) to be matched with the color of at least one of the thermochromic states of the thermochromic layer 720. Upon transition of the thermochromic layer 720 one of its thermochromic states, the writing applied to the clear layer 704 can thus be reversibly revealed or concealed.

In some examples, the clear layer 704 can be made from a clear polymer such as polycarbonate, polyethylene, polyethylene terephthalate, polypropylene, polyimide, polybutylene terephthalate, among others. In other examples, the clear layer can be made from a glass, a ceramic, a glass ceramic, examples of which include those used in touch sensitive mobile computing devices. Generally, any material that does not melt or have a glass transition temperature below 100° C. and has a transmittance in the visible spectrum of at least 70% (as described below) can be used for the clear layer 704.

It will be appreciated that the clear layer 704 is optically clear (or equivalently, optically transparent) such that the color of an underlying thermochromic layer 720 can be seen. In some embodiments, the clear layer 704 need not be perfectly clear or transparent but merely sufficient for the underlying thermochromic layer 720 color to conceal the writing applied to the clear layer 704. For example, the clear layer 704 may include some opacity or haze due to the presence of filler particles (e.g., micron or micron sized silica particles, inherent haze present in the homopolymer or polymer blend) or the natural decrease in optical clarity of the material itself (e.g., upon increasing thickness, the presence of manufacturing impurities). In some examples, this translates into a transmission of at least 70%, at least 75%, or at least 80% of light through the clear layer 704, with the remainder of the light not transmitted being absorbed or scattered or both.

In the embodiment shown, the clear layer 704 also includes an adhesive 708 disposed on a surface opposite the exposed surface on which writing material can be deposited. This adhesive 708 can be provided on the clear layer so as to attach one or more nanofiber yarns of an array 712 (also equivalently referred to layer of nanofibers 712) to a surface of the clear layer 704. Examples of the adhesive 708 are those that can be applied in a layer or a pattern so as to preserve the transparency of the clear layer 704, within the limits indicated above. Examples of the adhesive 708 include pressure sensitive adhesives, thermally sensitive adhesives, acrylate adhesives, urethane-based adhesives, polyisobutylene-based adhesives, epoxies, among others. In some examples, an adhesive is infiltrated into the carbon nanofiber yarns 712. In some examples, the adhesive 708 is applied to the clear layer 704 in a continuous layer or in separate discrete locations (such as stripes or dots of adhesive that are physically separated from one another). In still another example, complementary components of an adhesive system (e.g., a two-component epoxy) can be separately applied to the clear layer 704 and the carbon nanofiber yarns 712 (described below) so that physical contact between the treated clear layer 704 and carbon nanofiber yarns 712 completes the adhesive system, thus causing them to react and adhere together.

Carbon nanofiber yarns 712 are disposed between the clear layer 704 and the thermochromic layer 720. In the example display board 700, the carbon nanofiber yarns 712 are disposed between the adhesive 708 and the thermochromic layer 720. The carbon nanofiber yarns 712 can, in various examples, be multi-ply nanofiber yarns or single ply nanofiber yarns. Furthermore, the carbon nanofiber yarns 712 can be true twist yarns or false twist yarns. False twist yarns are described in U.S. patent application Ser. No. 15/844,756 which is incorporated herein in its entirety. It will be appreciated that in some embodiments of the example display board 700, both types of single ply and multi-ply nanofiber yarns can be used. The yarns may comprise single walled or multi-walled carbon nanotubes.

Furthermore, the carbon nanofiber yarns 712 can be infiltrated with any of a number of materials. For example, conductive microparticles or nanoparticles that increase the thermal and/or electrical conductivity of the carbon nanofiber yarns 712 can be infiltrated into the carbon nanofiber yarns 712 prior to installation within the example display board 700. In one example, silver nanoparticles approximately 200 nm in diameter can be infiltrated in with a solvent, such as toluene or isopropyl alcohol. The presence of these nanoparticles (or some other metallic or conductive nanoparticle) can facilitate transmission of thermal energy from a heat source to the thermochromic layer 720. In an alternative embodiment, nanoparticles or microparticles that have a high electrical resistivity and thus generate heat upon application of electricity can be infiltrated into the nanofiber yarns 712. For example, tungsten nanoparticles from 100 nm to 500 nm in diameter can be infiltrated into the carbon nanofiber yarns using a solvent (such as toluene or isopropyl alcohol). After removal of the solvent, the tungsten nanoparticles remain within the structure of the carbon nanofiber yarns 712. Upon application of an electrical current to the carbon nanofibers, which are good electrical conductors, the tungsten particles, which are electrical resistors, will generate heat. The heat is then quickly (e.g., within one or two seconds) conducted by the carbon nanofibers and transmitted to the thermochromic layer 720 so as to cause a thermochromic transition. Depending on the transition temperature of the thermochromic material, the transmitted heat can cause a thermochromic transition in less than 30 seconds. Similarly, other micro or nanoparticles can be infiltrated into a carbon nanofiber yarn to alter its thermal and/or electrical characteristics, including but not limited to iron, gold, copper, among others.

In some cases, a layer comprising carbon nanofiber yarns 712 can exhibit thermal conductivity of greater than 1.0, greater than 2.0 or greater than 3.0 W/(m-K). Similarly, carbon nanofiber yarns in an adhesive layer can improve the thermal conductivity of the adhesive layer by greater than 0.1, greater than 0.5, greater than 1.0, greater than 1.5 or greater than 3.0 W/(m-K).

The carbon nanofiber yarns 712 can be in any number of configurations that facilitate efficient and rapid heat transmission to and from the thermochromic layer 720. For example, in some embodiments the carbon nanofiber yarns of the plurality 712 are each linearly arranged (i.e., not in direct contact with one another) from one side of the example display 700 to the other. It is this configuration that is illustrated in FIGS. 7A and 7B. It will be appreciated that in some examples of the linear array, the carbon nanofiber yarns 712 are substantially parallel (having longitudinal axes within +/−30° of one another). While they may be arranged so as to not contact one another, this need not be the case. In other examples, the carbon nanofiber yarns 712 can be arranged in spirals, nested spirals, or in a grid in which a first set of substantially parallel nanofiber yarns are connected to (or in direct or indirect contact with) a crosswise or transversely arranged second set of substantially parallel nanofiber yarns. In certain embodiments, a pitch (e.g., the center to center distance between adjacent nanofiber yarns) in any of the arrays, grids, or arrangements can be within any of the following ranges: from 200 μm to 1 mm; from 500 μm to 750 μm; from 750 μm to 1 mm; from 1 mm to 5 mm; from 100 μm to 1 mm; from 250 μm to 750 μm. A diameter of an individual yarn can be within any of the following ranges: from 10 μm to 100 μm; from 10 μm to 50 μm; from 50 μm to 100 μm; from 15 μm to 50 μm.

Electrodes 716A and 716B (collectively, 716) are placed in contact with at least the nanofiber yarns 712. In some examples the electrodes 716 are placed in contact with both the nanofiber yarns 712 and the thermochromic layer 720. The electrodes 716 are connected to a power source (not shown) so that electrical power can be provided to the nanofiber yarns 712 via electrodes 716. Upon application of power through the power source to the electrodes 716, heat is generated within the nanofiber yarns 712 (via resistive heating mechanisms within the nanofibers, within infiltrated particles, or both). Heat resistively generated within and transmitted from the nanofiber yarns 712 to the thermochromic layer can then cause a thermochromic transition within thermochromic layer 720. In some examples the electrodes 716 are fabricated from strips of a conductive metal (e.g., copper, aluminum, and commercially available alloys of copper, aluminum, or other conductors).

In one example, the electrodes 716 are fabricated from strips of a conductive metal tape that includes an adhesive layer. The presence of an adhesive on a conductive metal tape facilitates fabrication and proper placement of the electrodes 716 relative to and in contact with the nanofiber yarns 712. In another example, the electrodes 716 can be connected to the nanofibers 712 via solder contacts. While carbon nanofiber yarns 712 may have a low adhesion with materials traditionally used for solders, the carbon nanofiber yarns 712 can be processed to include one or more metal layers, such as a first layer of tungsten that forms a tightly adhering carbide that is conformal to exposed surfaces of the nanofiber yarn (and/or exposed surfaces of the nanofibers that form the nanofiber yarn) and a second layer, such as copper, aluminum, gold, that is on and conformal with the tungsten carbide layer and the underlying nanofiber yarn (and/or nanofibers). These metallized layers (applied by e.g., physical vapor deposition, chemical vapor deposition, sputtering) on the carbon nanofiber yarns 712 can improve the adhesion with a solder material.

In the preceding examples, carbon nanofiber yarns 712 are oriented so that their longitudinal axes are parallel to (and in contact with) an adjacent surface of the thermochromic layer 720. In some examples, not shown, carbon nanofiber yarns 712 can be embedded in a matrix and placed on the thermochromic layer so that the longitudinal axes of the yarns are perpendicular to the adjacent surface of the thermochromic layer. For instance, parallel carbon nanofiber yarns can be embedded into a thermoplastic adhesive and then sliced with a microtome (or other similar device) to provide cross sections of adhesive/yarn composites. These slices can then be used to join, for example, the message film and the thermochromic layer to provide carbon nanotube yarns that are normal to the thermochromic layer and/or the heat source. This can provide advantageous thermal transfer properties in some circumstances.

The thermochromic layer 720 is integrated within the display 700. In the example 700 shown, the thermochromic layer 720 is disposed between the electrodes 716 and on a side of the nanofiber yarns 712 opposite that of the clear layer 704. However, it will be appreciated that this is not necessarily the case in all examples, and rather the thermochromic layer 720 can in some cases be placed between the nanofiber yarns 712 and the clear layer 704.

In some examples the thermochromic layer 720 can be a polymer film that is coated with, or filled with, thermochromic materials. These materials can include, but are not limited to, liquid crystal polymer molecules, organic and inorganic pigments, and leuco dyes. In other examples, thermochromic layer 720 is a paint, film, coating, or layer of one or more of a binder and a thermochromic material. The binders and/or films that can include a thermochromic material include, but are not limited to, polymer films (whether thermoplastic, thermosetting, elastomeric), paints, inks, powders and pigments among others. It will be appreciated that a wide variety of thermochromic materials (including polymer-encapsulated beads of thermochromic pigments) are available and can have a thermochromic transition at any of a variety of temperatures and transition between any of a variety of colors. Examples of these are available from ATLANTA CHEMICAL ENGINEERING LLC.

A backing plate 724 can then be applied to the assembly. The backing plate 724 can provide rigidity to the other elements of the example display board 700 so that the example display board can be conveniently written on and/or transported. Examples of the backing plate 724 include rigid polymers (e.g., polycarbonate), wood, aluminum plate, glass ceramics, among others.

FIG. 7B illustrates the example display board 700 in an assembled state.

### Experimental Results of Electrical Characteristics

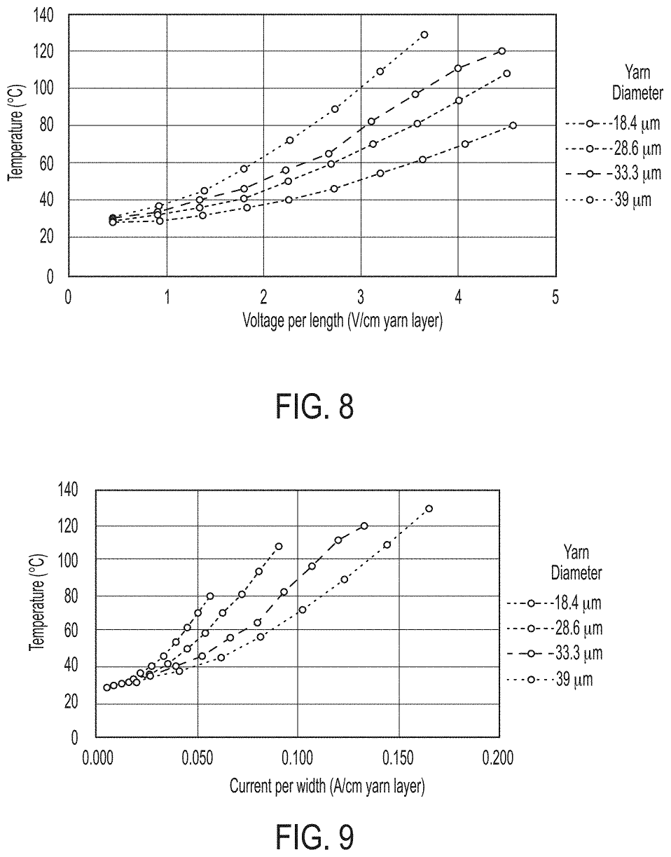

FIGS. 8-11B illustrate various depictions of the electrical characteristics of an example thermochromic display board, such as the one illustrated and described in the context of FIGS. 7A and 7B. Prior to describing the experimental results depicted in FIGS. 8-11B, the following description corresponds to a calculation for estimating power requirements for accomplishing a thermochromic transition in an example thermochromic nanofiber display board, as contemplated herein.

This illustrative calculation was based on a thermochromic nanofiber board that used a thermochromic material having a thermochromic transition at 45° C. (e.g., from a first thermochromic state to a second thermochromic state) and had a surface area of 67.65 cm² (based on a width of 12.3 cm and a height of 5.5 cm). The thermochromic material used was from ATLANTA CHEMICAL ENGINEERING LLC. The thermochromic material was formulated to transition from a red color to colorless (or “white”) at 45° C. The resistance of the board was measured to be approximately 26 Ohms (+/−5% according to normal measurement variation and measurement error) at an applied voltage of 15 V and an applied current of 0.62 Amps. The electrical power needed to cause the thermochromic transition (i.e., achieve 45° C. within the thermochromic layer) was 9.3 Watts, which normalized for the surface area of the display was 0.14 Watts/cm².

As will be appreciated in light of the description of FIGS. 8-11, the power needed to cause a thermochromic transition with a display board of the present disclosure is, generally, related to a diameter of the nanofiber yarns, pitch (or spacing) between the yarns (or alternatively, a number of uniformly spaced yarns), a length of the board (or more specifically, a length of a thermochromic layer within the board), and a thermochromic transition temperature of the thermochromic material used. For example, the electrical resistance of a display board of the present disclosure is inversely related to the number of yarns within a nanofiber layer (e.g., layer 712 in the example of FIGS. 7A, 7B)—the more yarns, the lower the electrical resistance of the display board. The lower the electrical resistance, the lower the voltage (and less power) needed to cause a thermochromic transition for a given transition temperature. The electrical resistance of a display board is also directly (although not necessarily linearly) related to an area of a board. The larger the area of the board, generally the higher the electrical resistance, and the more power needed to cause a thermochromic transition for a given transition temperature.

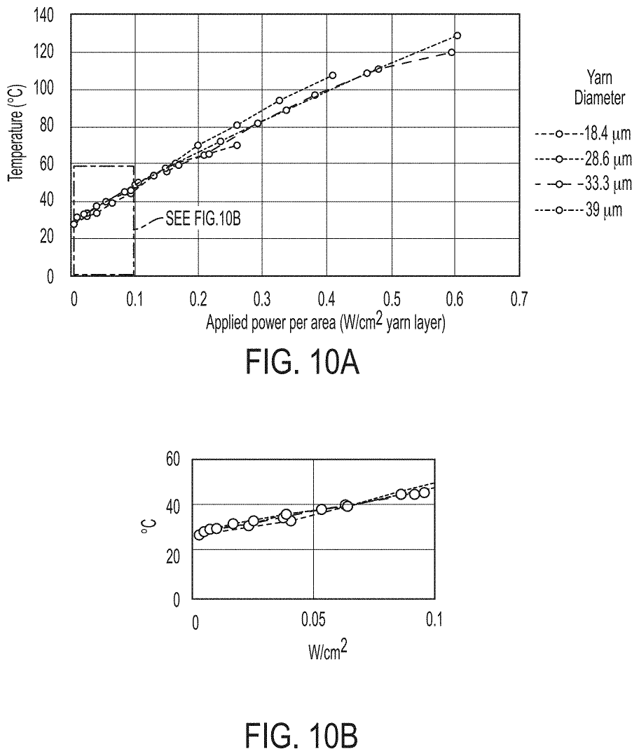

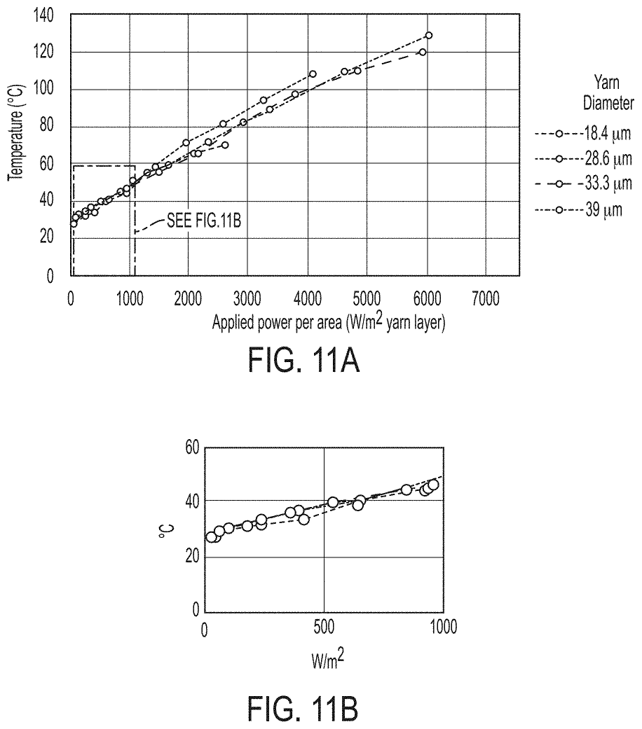

FIGS. 8-11B illustrate various experimental results of temperatures that can be achieved in nanofiber thermochromic displays of the present disclosure as a function of nanofiber yarn diameter and normalized by a length and width of the nanofiber yarn layer (FIGS. 8 and 9, respectively) and by area of the nanofiber yarn layer (FIGS. 10A, 10B and 11A, 11B). It will be appreciated that the length and area of the yarn layer, and not the yarn itself, is used for convenience because it is easier to measure the macroscopic dimensions of the layer than the microscopic dimensions of yarn itself.

The thermochromic boards used in the examples of FIGS. 8-11B were fabricated using 37 nanofiber yarns having a pitch (center-to-center distance between adjacent yarns) of 800 μm. The various diameters of the nanofiber yarns are indicated in the legend associated with each figure. The measurement temperature of approximately 80° C. (+/−2°, within normal process variation and measurement error) was achieved uniformly over the board about 20 seconds (+/−2 seconds) after initial application of the voltage to the electrodes of the display board.

Turning first to FIG. 8, it will be apparent upon inspection that the more voltage that is applied per unit of yarn layer length (which as indicated above for linearly arranged nanofibers is directly proportional to yarn length), the greater the temperature can be achieved in the thermochromic layer. It will also be noted that for a given normalized applied voltage, the temperature increases with increasing nanofiber yarn diameter.

FIG. 9 illustrates a similar pattern in that increasing a normalized current applied to a nanofiber yarn also increases a temperature of the thermochromic layer. Unlike the pattern in FIG. 8 however, the larger the yarn diameter for a given applied normalized current, the lower the temperature.

FIGS. 10A, 10B and 11A, 11B illustrate applied power per unit area of the nanofiber yarn layer. FIGS. 10A, 10B present the applied power per square centimeter whereas FIGS. 11A, 11B present the applied power per square meter. The trend and the absolute normalized values for the various yarn diameters are very similar.

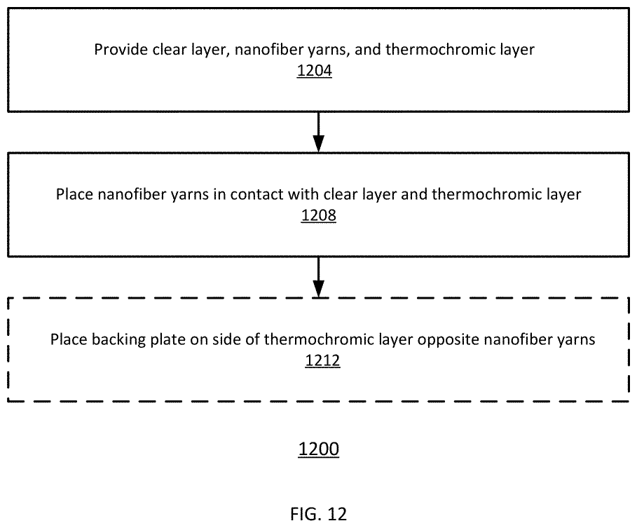

FIG. 12 is a method flow diagram illustrating an example method 1200 for assembling a thermochromic nanofiber drawing board, in an example of the present disclosure. The method 1200 begins by providing 1204 the components of the display board described above: the clear layer, the plurality of carbon nanofiber yarns, and the thermochromic layer. The nanofiber yarns are placed 1208 in contact with both the clear layer and the thermochromic layer, and all three layers are pressed together to encourage contact therebetween. Optionally a backing plate can be placed 1212 on a side of the thermochromic layer opposite the nanofiber yarns to, as described above, provide support and rigidity to the other layers.

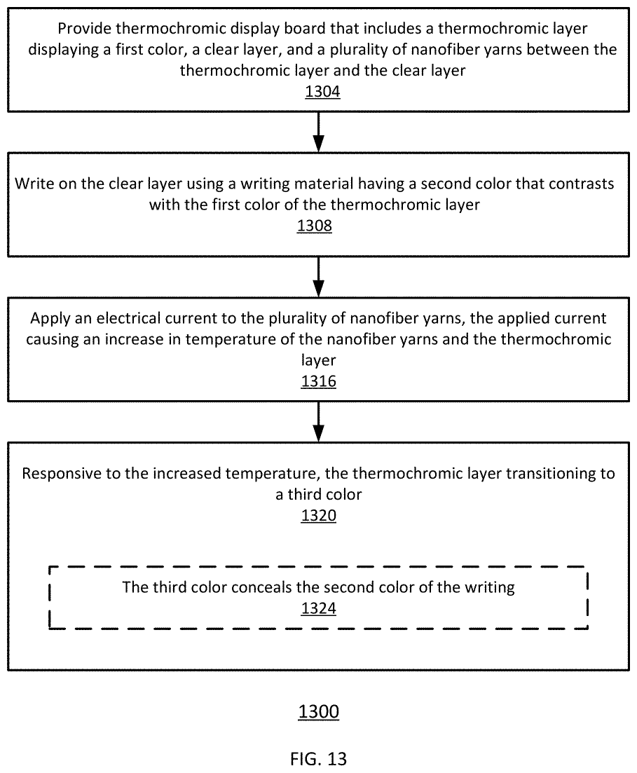

FIG. 13 is a method flow diagram illustrating an example method 1300 for using a thermochromic nanofiber drawing board, in an example of the present disclosure. The method 1300 begins by providing 1304 a thermochromic display board that includes a thermochromic layer displaying a first color, a clear layer, and a plurality of nanofiber yarns between the thermochromic layer and the clear layer. The method 1300 continues with writing 1308 on the clear layer using a writing material having a second color that contrasts with the first color of the thermochromic layer. In this context, “contrast” can mean that the second color is visually distinguishable from first color. In one example, this can mean a Weber contrast threshold value of at least 0.3, at least 0.4, at least 0.5. In one example, “matching” can mean a Weber contrast threshold value of less than 0.5, less than 0.4, or less than 0.3. An electrical current can then be applied 1316 to the plurality of nanofiber yarns, the applied current causing an increase in temperature of the nanofiber yarns and the thermochromic layer. Responsive to the increased temperature, the thermochromic layer transitions 1320 to a third color. In one example, the third color matches the second color, thus concealing 1324 the writing in the second color. In this case, the concealing 1324 means that the color of the writing and the color of the thermochromic layer have a Weber contrast value above the threshold value.

### FURTHER CONSIDERATIONS

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A method comprising:
providing a thermochromic display board that includes:
a thermochromic layer displaying a first color;
an optically clear layer over the thermochromic layer;
a plurality of carbon nanofiber yarns between the thermochromic layer and the optically clear layer;
marking the optically clear layer with a writing material having a second color that contrasts with the first color of the thermochromic layer;
applying an electrical current to the plurality of carbon nanofiber yarns, the applied current causing an increase in temperature of the carbon nanofiber yarns; and
responsive to the increased temperature of the carbon nanofiber yarns, conducting heat to the thermochromic layer thereby causing the thermochromic layer to transition a third color.

2. The method of claim 1, wherein the third color of the thermochromic layer does not contrast with the second color of the writing.

3. The method of claim 1, wherein the third color matches the second color of the writing.

4. The method of claim 3, wherein a Weber contrast value between the second color of the marking on the optically clear layer and the third color of the thermochromic layer is less than 0.3.

5. The method of claim 1, wherein a Weber contrast value between the second color of the marking on the optically clear layer and the first color of the thermochromic layer is greater than 0.3.

6. The method of claim 1, wherein the transition to the third color occurs less than 20 seconds after the electrical current is initially applied to the plurality of carbon nanofiber yarns.

7. The method of claim 1, wherein the applied electrical current is has a voltage of 15 Volts.

8. The method of claim 1, wherein the plurality of carbon nanofiber yarns is configured to increase a temperature of the thermochromic layer by at least 25° C. in less than 30 seconds in response to an applied power of at least 500 Watt/meter².

9. The method of claim 1, wherein the thermochromic layer has a thermochromic transition temperature of 45° C.+/−5° C.

10. The method of claim 1, wherein the thermochromic layer comprises a leuco dye.

11. The method of claim 10, wherein the leuco dye comprises a plurality of polymer beads, the leuco dye disposed within the polymer beads.

12. A method comprising:
providing a thermochromic display board that includes:
a thermochromic layer displaying a first color;
an optically clear layer over the thermochromic layer;
a plurality of nanofiber yarns between the thermochromic layer and the optically clear layer;
marking the optically clear layer with a writing material having a second color that matches the first color of the thermochromic layer;
applying an electrical current to the plurality of nanofiber yarns, the applied electrical current causing an increase in temperature of the nanofiber yarns; and
responsive to the increased temperature of the nanofiber yarns, conducting heat to the thermochromic layer thereby causing the thermochromic layer to transition a third color.

13. The method of claim 12, wherein the plurality of nanofiber yarns exhibits a thermal conductivity of greater than 3.0 W/(m-K).

14. The method of claim 12, further comprising a second material disposed within the nanofiber yarns of the plurality of nanofiber yarns, wherein the second material is one of an electrical conductor or an electrical resistor.

15. The method of claim 14, wherein the second material comprises a plurality of tungsten nanoparticles.

16. The method of claim 14, wherein the third color contrasts with the second color of the marking.

17. The method of claim 16, wherein a Weber contrast value between the second color of the marking on the optically clear layer and the third color of the thermochromic layer is greater than 0.3.

18. The method of claim 15, wherein a Weber contrast value between the second color of the marking on the optically clear layer and the first color of the thermochromic layer is less than 0.3.

19. The method of claim 12, wherein the plurality of carbon nanofiber yarns is configured to increase a temperature of the thermochromic layer by at least 25° C. in less than 30 seconds in response to an applied power of at least 500 Watt/meter².

20. The method of claim 19, wherein the applied current is 0.62 Amps.
